(19) United States
(12) Patent Application Publication
(10) Pub. No.: US 2003/0097657 A1
(43) Pub. Date: May 22, 2003

(54) Method and system for delivery of targeted programming

(76) Inventors: Yiming Zhou, Union City, CA (US); Ariel Bentolila, Santa Clara, CA (US); Kulbhushan Kaushal, San Jose, CA (US); Labeeb Ismail, Fremont, CA (US); Richard Humpleman, Fremont, CA (US)

Correspondence Address: SHERMAN & SHERMAN, A.P.C., 2029 CENTURY PARK EAST, SEVENTEENTH FLOOR, LOS ANGELES, CA, 90067, US

(21) Appl. No.: 09/953,327

(22) Filed: Sep. 14, 2001

Related U.S. Application Data
(60) Provisional application No. 60/232,644, filed on Sep. 14, 2000.
(60) Provisional application No. 60/253,280, filed on Nov. 27, 2000.

(51) Int. Cl. G06F 3/00; H04N 5/445; G06F 13/00

(52) U.S. Cl. 725/46; 725/38; 725/61

(57) ABSTRACT

A method for displaying a TV program to a viewer comprising receiving a plurality of TV programs, allowing the viewer to select one of the plurality of received TV programs for viewing, and responding to the viewer selection by displaying the viewer selected program and displaying additional programs in accordance with previously specified display criteria, the additional programs selected in accordance with the previously determined viewing preferences of the viewer. The display criteria are specified by the head-end operator and may include display schedule criteria, selected program criteria, and previously determined viewing preferences criteria. The additional programs may include advertisements.

### RELATED APPLICATIONS

This patent application claims the priority of provisional patent applications serial No. 60/232,644, filed Sep. 14, 2000 and serial No. 60/253,280 filed Nov. 27, 2000.

### BACKGROUND OF THE INVENTION

In the TV-Anytime document authored by Peter van Beek of Sharp Laboratories of America and dated Aug. 23, 2000, a draft specification of descriptors and description schemes for Electronic Program Guides or Electronic Content Guides is proposed. The TV Anytime Forum is an association of organizations which seeks to develop specifications to enable audio-visual and other services based on mass-market high volume digital storage.

The basic assumptions and design principles of the proposed specification of the Electronic Program Guide contained in the EPG specification document are:

It is a layered design containing descriptions ranging from those that are core (e.g., identifying and locating content) to those that are basic (title, abstract, actors etc.) and advanced (audiovisual titles, extensive textual summaries etc.).

Its capability to hold extensive information allows content guides to be arranged and presented to the user in multiple different ways, perhaps according to user preferences (e.g., Robert Redford channel). Current ATSC-PSIP and DVB-SI specifications [1,2] do not have, for example, a well-defined mechanism to specify actors or directors.

Its design is consistent with the TVA framework, in which selection of program content based on program metadata is separated from localization of the program content. To facilitate this separation, the design includes a content reference identifier, with which the metadata is associated. Localization implies a mapping from the content reference identifier to a location. The design of the EPG description schemes allows a wide range of scenarios in this respect, including those with unidirectional and bidirectional links between the content provider and the user.

It has been designed such that the structure can co-exist with ATSC-PSIP [1] or DVB-SI [2], when they are available, and in fact utilize the tuning and service information tables of these two specifications.

The description scheme-XML based framework enables the electronic guide descriptions to co-exist with other advanced description schemes (e.g., those that are included in MPEG-7, for example, Summarization Description Schemes) in the very same framework. These advanced description schemes allow functionalities to the user so that the user can consume the content in ways that fits to his/her preferences, e.g., by consuming highlights of a program that are created on the basis of a preferred theme in the program such as the goals in a soccer game.

Its design extends ATSC and DVB specifications to scenarios that are beyond TV broadcast. E.g., Internet streaming, Video on Demand, Electronic Content Guide in a home setting where local content (e.g., on DVDs) are also included.

The ProgramInformation Description Scheme (DS) contains the information related to a single audiovisual program, e.g. TV program, that is necessary to build an Electronic Program Guide.

Furthermore, the ProgramInformation DS as defined in the EPG specification document consists of four parts:

Mapping from content identifier to locator;

Basic program information;

Extended program information;

Program event information.

The first element serves to map a content reference identifier to the location information of a program, effectively allowing localization. The basic program information consists of the most basic information needed to schedule a program, such as for example title and genre. The extended program information contains further useful information for describing a program textually and technically. This is useful for enhanced applications. The program event information further contains the tools to describe a particular program instance or program event. Multiple program events or instances may exist or occur for a single source program. For instance, a program may be broadcast on a particular channel at multiple occasions, on different times. Particular events, such as broadcast events, may differ in their program attributes from each other. For instance, the first showing of a program may be live, while later instances can be regarded as repeats. Another example is a case where a particular program is broadcast on different channels, one through a free channel, and another through a pay-per-view service.

It should be understood that the ProgramInformation DS serves as a structure to link all the pieces of information together. Various scenarios in different application environments exist in which not all the various parts of the ProgramInformation DS are linked together into one description, but in other cases they may be. For example, in some cases the localization information may be part of a separate description and may be obtained from other sources than the other program content metadata. In other cases, these parts may in fact be linked together in a single description. Also, different descriptions may share description parts through the use of identifiers and identifier references. Different parts of the scheme proposed may exist in standalone descriptions.

Thus, the basic program information, the extended program information and the program event information each contain the appropriate content identifier(s), effectively linking the descriptors in each of these parts to a particular program. The overall ProgramInformation DS can be used to ti.e. all the description parts together, and, in certain cases, link them to a locator.

The EPG specification document also contains the specification of the syntax and semantics of the proposed description schemes, as well as examples, as listed below.

ProgramInformation DS

The ProgramInformation DS contains all the information related to a single audiovisual program, e.g. TV program, that is necessary to build an Electronic Program Guide.

[image]

[image]

[image]

[image]

[image]

[image]

[image]

[image]

[image]

[image]

[image]

[image]

[image]

[image]

[image]

[image]

| Name | Definition |
|---|---|
| ProgramInformationType | A data type used to specify all |
| | information related to a single |
| | audiovisual program, e.g. TV program, for |
| | inclusion in an Electronic Program Guide |
| | (EPG). |
| LocationInformation | Location information related to this |
| | program. This part of the description |
| | specifies where the program material can |
| | be found (both in space and time). |
| LocationInformationRef | Reference to a description with location |
| | information related to this program. Shall |
| | refer to the id of a LocationInformation |
| | element. |
| BasicInformation | Basic information related to this program. |
| | This part of the description specifies |
| | basic EPG program attributes. |
| BasicInformationRef | Reference to a description with basic |
| | information related to this program. Shall |
| | refer to the id of a BasicInformation |
| | element. |
| ExtendedInformation | Extended information related to this |
| | program. This part of the description |
| | specifies more detailed EPG program |
| | attributes. |
| ExtendedInformationRef | Reference to a description with extended |
| | information related to this program. Shall |
| | refer to the id of an ExtendedInformation |
| | element. |
| EventInformation | Event information related to this program. |
| | This part of the description specifies |
| | attributes related to specific instances |
| | of a program (e.g. corresponding to a |
| | particular broadcast event). |
| EventInformationRef | Reference to a description with event |
| | information related to this program. Shall |
| | refer to the id of an EventInformation |
| | element. |
| id | Description instance identifier. |
| tag | Description instance tag. |
| ProgramLocationType | A data type used to specify the location |
| | of a program, i.e. where the program |
| | material can be found. It effectively |
| | associates a content identifier with a |
| | location. |
| ContentReferenceID | Content ID that is used to refer to this |
| | program. |
| ProgramLocator | Locator of the program material. |
| id | Description instance identifier. |
| tag | Description instance tag. |
| ProgramBasicInformation- | A data type used to specify the basic |
| Type | information needed to include the program |
| | in a Program Guide. |
| ContentReferenceID | Content ID that is used to refer to this |
| | program. |
| ProgramIdentifier | Unique identifier of the program (e.g. |
| | UPID). |
| GroupRef | A reference to the group of programs that |
| | the program is part of (e.g. a TV series). |
| Title | Textual title of the program. The language |
| | in which the title is expressed is |
| | indicated by the xml: lang attribute. |
| | Multiple title descriptors may be |
| | included. The type of title (main, |
| | original or alternative) is indicated by |
| | the type attribute. |
| Version | Version of the program material. |
| EpisodeNumber | Episode number of the program, in case it |
| | is part of a series. |
| EpisodeTitle | Episode title of the program, in case it |
| | is part of a series. |
| SeriesTitle | Series title, in case the program is part |
| | of a series. |
| ParentalGuidance | Parental guidance or viewer discretion |
| | descriptor, with associated semantics: |
| | Country - Code that indicates the |
| | country for which the parental guidance |
| | descriptor is defined. |
| | ParentalRatingScheme - Denotes the |
| | specific scheme used for rating the |
| | input program. |
| | ParentalRatingValue - The actual rating |
| | of the program according to the rating |
| | scheme specified above. |
| | MinimumAge - The minimum |
| | recommended age for consumers |
| | of the program, in years. |
| Genre | The genre of the program content. Multiple |
| | genre descriptors may be included. The |
| | type of genre (main, sub or other) is |
| | indicated by the type attribute. For basic |
| | program information, it is expected that |
| | the type attribute will be set to main. |
| | The type other enables 3^{rd} party |
| | broadcasters to specify extra genre |
| | information. |
| Keywords | Keywords associated with the program |
| | content. Multiple keyword descriptors may |
| | be included. The type of keyword (any, |
| | main or sub) is indicated by the type |
| | attribute. For basic program information, |
| | it is expected that type attribute will be |
| | set to any. The type any can be used for |
| | non-category keywords. |
| Abstract | Textual description of the program |
| | content. Multiple abstract descriptors of |
| | different lengths may be included. The |
| | number of words in the textual abstract is |
| | indicated by the nr attribute. |
| Creator | A creator of the program material. |
| | Multiple creator descriptors may be |
| | included. A creator may be an individual |
| | (such as an actor, director, producer, |
| | host, anchor, composer, narrator or |
| | others), a group of people, or an |
| | organization. The type or function of a |
| | creator is indicated by the Role |
| | descriptor. |
| Character | A fictional character that is part of the |
| | content or that specifies a role played by |
| | an actor. Multiple character descriptors |
| | may be included. This descriptor includes |
| | the name of the character, and either (i) |
| | the name, or (ii) a reference to, the |
| | actor that performs the role of that |
| | character. |
| ProductionYear | Year of production of the program. |
| ProductionCountry | Country of production of the program. |
| CreationLocation | Spatial location of the content creation. |
| CreationDate | Time and date of the content creation. |
| Language | The language of the spoken content of the |
| | program. Multiple language descriptors may |
| | be included. The language specified by the |
| | descriptor (main, original, alternative) |
| | is indicated by the type attribute. The |
| | descriptor original is used to describe |
| | the original language of the program when |
| | the program is dubbed. |
| Dubbed | A flag indicating whether the program |
| | audio was dubbed. |
| Subtitled | A flag indicating whether the program |
| | includes subtitles. |
| SubtitleLanguage | If present, the language of the subtitles. |
| | Multiple subtitle-language descriptors may |
| | be included. |
| CCService | References the closed-caption services for |
| | this program. |
| AudioSigning | A flag indicating whether the program |
| | includes signing captions. |
| TitleImage | Locates image media representing the |
| | program content, e.g. a thumbnail image or |
| | logo. |
| RelatedMaterialURL | Reference to media that is related to the |
| | program content. Multiple related-material |
| | link descriptors may be included. |
| AspectRatio | Aspect ratio of the visual program |
| | material, represented by the two |
| | attributes width and height (e.g. 4:3, |
| | 16:9, 2.35:1). |
| Color | Flag indicating whether the visual program |
| | material is in color or not. |
| HD | Flag indicating whether the visual program |
| | material is in high-definition format or |
| | not. |
| Stereo | Flag indicating whether the audio program |
| | material is in stereo or not. |
| AudioChannels | The number of audio-channels of the |
| | program. |
| ExtensionDescriptor | An abstract descriptor that provides a |
| | generic template for future definition of |
| | new descriptors as they are deemed |
| | necessary. |
| id | Description instance identifier. |
| tag | Description instance tag. |
| ProgramExtended- | A data type used to specify the extended |
| InformationType | information associated with a program |
| | included in a Program Guide. |
| ContentReferenceID | Content ID that is used to refer to this |
| | program. |
| ProgramIdentifier | Unique identifier of the program (e.g. |
| | UPID). |
| Genre | Specifies the genre of the program. |
| | Multiple genre descriptors may be |
| | included. The type of genre (main, sub or |
| | other) is indicated by the type attribute. |
| | For extended program information, it is |
| | expected that the type attribute will be |
| | set to sub or other, to complement the |
| | genre specification provided in basic |
| | program information. |
| Keywords | Keywords associated with the program |
| | content. Multiple keyword descriptors may |
| | be included. The type of keyword (any, |
| | main or sub) is indicated by the type |
| | attribute. For extended program |
| | information, it is expected that type |
| | attribute will be set to main or sub, to |
| | complement the keywords provided in basic |
| | program information. |
| VideoSystem | Denotes the video system in which the |
| | program data is broadcast (e.g. PAL, NTSC, |
| | SECAM). |
| VisualCodingFormat | Denotes the coding format of the input |
| | visual content (e.g. MPEG-1, JPEG2000). |
| FrameWidth | The width of the input images/frames in |
| | pixels. |
| FrameHeight | The height of the input images/frames in |
| | pixels. |
| FrameRate | The frame rate of the input video stream, |
| | in Hz. |
| Progressive | A flag that specifies whether the input |
| | video is in progressive or interlaced |
| | format. |
| AudioCodingFormat | Specifies the coding format of the input |
| | audio stream. |
| AudioSamplingRate | Specifies the sampling rate of the input |
| | audio stream, in Hz. |
| FileFormat | The file format or MIME type of the input |
| | AV content. |
| FileSize | The size of the AV media file in bytes. |
| BitRate | The bit rate of the AV content required |
| | for synchronous transmission, in bits/sec. |
| TitleVideo | Specifies a video segment or clip that |
| | will be used as or with the title sequence |
| | for the program |
| TitleAudio | Specifies an audio segment or clip that |
| | will be used as or with the title sequence |
| | for the program |
| ExtensionDescriptor | An abstract descriptor that provides a |
| | generic template for future definition of |
| | new descriptors as they are deemed |
| | necessary. |
| id | Description instance identifier. |
| tag | Description instance tag. |
| ProgramEventInformation- | A data type used to specify the |
| Type | information associated with every instance |
| | of a program. |
| ContentReferenceID | Content ID that is used to refer to this |
| | program. |
| ProgramIdentifier | Unique identifier of the program (e.g. |
| | UPID). |
| Duration | Duration of the program. |
| Repeat | Flag that specifies whether the program is |
| | a repeat of previously broadcast material. |
| Live | Flag that specifies whether the program is |
| | broadcast live. |
| FirstShowing | Flag that specifies whether the given |
| | instance is the first showing of the |
| | program. |
| LastShowing | Flag that specifies whether the given |
| | instance is the final showing of the |
| | program. |
| Encrypted | Flag that specifies whether the program is |
| | encrypted for restricted viewing. |
| PayPerView | Flag that specifies whether the program is |
| | pay-per-view or free of charge. |
| RightsService | Reference to individual services that |
| | provide the rights management information |
| | associated with the program. |
| ReBroadcastDate | Specifies the date when the program will |
| | be broadcast again. |
| ServiceProvider | Reference to the resources (web etc.) of |
| | the program service provider |
| ParentalGuidance | Parental guidance or viewer discretion |
| | descriptor, with associated semantics: |
| | Country - Code that indicates the |
| | country for which the parental guidance |
| | descriptor is defined. |
| | ParentalRatingScheme - Denotes the |
| | specific scheme used for rating the |
| | input program. |
| | ParentalRatingValue - The actual rating |
| | of the program according to the rating |
| | scheme specified above. |
| | MinimumAge - The minimum |
| | recommended age for consumers |
| | of the program, in years. |
| AspectRatio | Aspect ratio of the visual program |
| | material, represented by the two |
| | attributes width and height (e.g. 4:3, |
| | 16:9, 2.35:1). |
| Color | Flag indicating whether the visual program |
| | material is in color or not. |
| HD | Flag indicating whether the visual program |
| | material is high-definition or not. |
| Stereo | Flag indicating whether the audio program |
| | material is stereo or not. |
| AudioChannels | The number of audio-channels of the |
| | program. |
| VideoSystem | Denotes the video system in which the |
| | program data is broadcast (e.g. PAL, NTSC, |
| | SECAM). |
| VisualCodingFormat | Denotes the coding format of the input |
| | visual content (e.g. MPEG-1, JPEG2000). |
| FrameWidth | The width of the input images/frames in |
| | pixels. |
| FrameHeight | The height of the input images/frames in |
| | pixels. |
| FrameRate | The frame rate of the input video stream, |
| | in Hz. |
| Progressive | A flag that specifies whether the input |
| | video is in progressive or interlaced |
| | format. |
| AudioCodingFormat | Specifies the coding format of the input |
| | audio stream. |
| AudioSamplingRate | Specifies the sampling rate of the input |
| | audio stream, in Hz. |
| FileFormat | The file format or MIME type of the input |
| | AV content. |
| FileSize | The size of the AV media file in bytes. |
| BitRate | The bit rate of the AV content required |
| | for synchronous transmission, in bits/sec. |
| ExtensionDescriptor | An abstract descriptor that provides a |
| | generic template for future definition of |
| | new descriptors as they are deemed |
| | necessary. |
| id | Description instance identifier. |
| tag | Description instance tag. |

ProgramInformation Examples

In the following example, basic program descriptive data is received separately from the location data of the program. This achieves separation of selection (using the program descriptors) from location resolution (using the mapping from content reference identifier to a location). The content reference identifier is the link between the two descriptions.

<ProgramInformation>
<BasicInformation>

<ContentReferenceID>

http://media.nbz.com/programs/contentids/NBZ-FR-1999

</ContentReferenceID>
<Title type=“main” >Friendz</Title>
<Version>3</Version>
<EpisodeNumber>10</EpisodeNumber>
<ParentalGuidance>

<Country>us</Country>
<MinimumAge>10</MinimumAge>

</ParentalGuidance>
<Genre type=“main”>Situation comedy</Genre>
<Language type=“main”>en</Language>
<Subtitled>false</Subtitled>

............
............

</BasicInformation>
</ProgramBasicInformation>
<ProgramLocation id=“proglocationa>

<ContentReferenceID>

http://media.nbz.com/programs/contentids/NBZ-FR-1999

</ContentReferenceID>
<ProgramLocator>

http://media.nbz.com/programs/media/friendz.mp2

</ProgramLocator>

</ProgramLocation>

In the following example, sharing of program descriptive data is illustrated. The program is available in two locations (in time and place), but both versions share the same basic and extended information. Hence this common part of the description is provided only once, and subsequently referenced by the second location instance. The programs differ in their event information, namely their location is different, and format attributes are different.

<ProgramInformation id=“proginfoa”>

<LocationInformation ID=“locationa” tag=“1”>

<ContentReferenceID>

http://media.nbz.com/programs/contentids/NBZ-FR-1999

</ContentReferenceID>
<ProgramLocator>

http://media.nbz.com/programs/media/friendz.mp2

</ProgramLocator>

</LocationInformation>
<BasicInformation id=“basicinfoa”>

<Title xml:lang=“en” type=“main”>Friendz</Title>
<Version>3</Version>
<EpisodeNumber>10</EpisodeNumber>
<ParentalGuidance>

<Country>us</Country>
<MinimumAge>10</MinimumAge>

</ParentalGuidance>
<Genre type=“main”>Situation comedy</Genre>
<Language type=“main”>en</Language>
<Subtitled>false</Subtitled>

............
............

</BasicInformation>
<ExtendedInformation id=“xtendinfoa”>

<Genre type=“sub”>Drama</Genre>
<VideoCodingSystem>ATSC</VideoCodingSystem>
<Progressive>false</Progressive>

............
............

</ExtendedInformation>
<EventInformation id=“eventinfoa”>

<Repeat>true</Repeat>
<Live>false</Live>
<PayPerView>false</PayPerView>
<RightsService>

http://media.nbz.com/programs/rights/friendz/

</RightsService>
<AspectRatio width=“4” height=“3”/>
............
............

</EventInformation>

</ProgramInformation>
<ProgramInformation id=“proginfob”>

<LocationInformation ID=“locationb”>

<ContentReferenceID>

http://media.nbz.com/programs/contentids/NBZ-FR-1999

</ContentReferenceID>
<ProgramLocator>
http://anothermedia.nbz.com/moreprograms/media/friendz.mp2
</ProgramLocator>

</LocationInformation>
<BasicInformationRef>

proginfoa.xml#basicinfoa

</BasicInformationRef>
<ExtendedInformationRef>

proginfoa.xml#xtendinfoa

</ExtendedInformationRef>
<EventInformation id=“eventinfob”>

<Repeat>true</Repeat>
<Live>false</Live>
<PayPerView>true</PayPerView>
<RightsService>

http://media.nbz.com/programs/rights/friendz/

</RightsService>
<AspectRatio width=“16” height=“9”/>
............
............

</EventIformation>

</ProgramInformation>

As exemplified by the above, Future TV systems will use computer based end-user equipment, i.e. TVs with program storage. Intelligent agents will learn or will be told the program preferences of the viewer and select programs from the many broadcasts and store them for real-time or later viewing. New business models are thus required to support the rights of the broadcasters, program copyright owners and other agents and system operators.

### BRIEF SUMMARY OF THE INVENTION

In one aspect, the present invention provides methods to enable such new business models that will give rights owners influence over the effective ‘production’ made by the end-user equipment (TV, STB) and the program audience. Both long programs, e.g. movies, and short programs, e.g. commercials, contain metadata information to enable the rights owners to target their material. Defined target types include the time at which the program is to be shown, the type or genre of programs to be shown, the households or individual demographics to which the programs are to be shown, viewers who have demonstrate prior interest in certain products or programs. In this manner, both the traditional business model and new models are fully supported.

The Targeting is in two parts. The first part, If-Audience, allows audience selection (e.g. demographic targeting) for the program, and the second part, Then-Presentation allows presentation or production selection (e.g. targeting a time or insertion in another program). There is also a final term (Else) to define what to do if the targets are not successful.

A Target is formed as a logical expression using logical operators like NOT, AND, OR, ANDNOT and ORNOT and terms of the aforementioned types. The number of terms may be small or large in number and can be used to define a very specific target(s) or broad target(s) as required. A money attribute optional with each term allows programming decisions based on cost/revenue used for example in the likely event of multiple suitable programs competing for the viewer's attention. Accounting for the cost of some programming can be offset by credit from advertising impressions.

In another aspect, the present invention provides a method for displaying a TV program to a viewer, including receiving a plurality of TV programs; allowing the viewer to select one of the plurality of received TV programs for viewing; and responding to the viewer selection by displaying the viewer selected program and displaying additional programs in accordance with previously specified display criteria, the additional programs selected in accordance with the previously determined viewing preferences of the viewer. The additional programs may be stored in accordance with the display criteria. The display criteria may include display schedule criteria, selected program criteria, and previously determined viewing preferences criteria. The method may further include receiving a plurality of additional programs; receiving the display criteria for each additional program together with each respective additional program; and storing a plurality of additional programs selected in accordance with the previously determined viewing preferences.

In a further aspect, the present invention provides a method for displaying a TV program to a viewer including transmitting a plurality of TV programs for selection therebetween by the viewer, and transmitting a plurality of additional programs for selection therebetween in accordance with previously determined viewing preferences of the viewer, the selected additional programs for display to the viewer in accordance with previously specified display criteria.

### BRIEF DESCRIPTION OF THE DRAWINGS

FIG. 1 is a diagram of an EPG including a virtual channel; and

FIG. 2 is schematic diagram of the architecture of a programming targeting system according to the invention.

### DETAILED DESCRIPTION OF THE INVENTION

A new Television System model based on recent advances in Digital Television and Computer technology can advantageously replace the traditional TV industry system and business model of 50+ years standing. While initially Digital TV seemed to be merely a digital replacement of the analog technology systems (NTSC and PAL), albeit with high definition picture quality available, now a radically different, new generation TV system model has come to light. This includes commercial technology and much industry-generated technology and standards including MPEG, SMPTE, ATSC and TV Anytime.

Digital conversion and compression allow the TV signal to be represented efficiently as digital computer data and stored on a computer Hard Disk Drive (HDD). This together with recent and expected further advances in HDD technology allow hours of video to be saved at the viewers home in a Digital Television (DTV), Set Top Box (STB) or other devices accessible via a Home Network. The time-shifting video recorder systems (PDR), examples already on sale, convert all TV signals to compressed-digital (e.g. MPEG2) and pass them via Hard Disk Drive (HDD) storage prior to presentation. PDR concurrent record and replay,—effectively a gigantic random access buffer and a generic capability with HDD storage, enables the simultaneous replay of display video stream and recording of new video information ie programs and commercials (advertising programs-Ad), for possible later replay.

With PDR systems a sophisticated EPG is provided, using specially accessed program metadata (special access sometimes required for the legacy analog case or inadequately developed digital case), to allow the viewer to select a program for view or record. Advanced technology ‘automatic preference determination’ addresses the ease of use aspect, providing the viewer with a selection of preferred program titles and also drive an automatic recording system to provide a selection of preferred programs. Also, and more importantly, it enables viewer profiling that leads to an improved target advertising system for TV commercials compared to the traditional model.

The combination of the following technology items allow, in end-user equipment, all broadcast Programs, Ad and non-Ad, to be identified, selectively saved and later more selectively replayed as a channel stream for presentation to the viewer:

1) Digital TV broadcast technology (MPEG2) or combination of analog NTSC and digital data (e.g. VBI or Internet data) to give the same data capability,

2) Intelligent Digital TV type, end-user equipment ie including computer and HDD storage (PDR),

3) Program (Ad and non-Ad) content description—EPG Metadata, plus identifying mechanism for Program video transitions (Ad and non-Ad), thus enabling video to be treated as information. Return path metadata may be also required.

The new TV system: Information Broadcast to Intelligent-TV, is very different from the traditional TV system: Prepared Programming Streams Broadcast to Dumb-TV. The full potential is an incredible new TV system where the broadcast channels are alive 24 hours per day transmitting a much richer and fuller set of programming and each intelligent TV, running preference algorithms, picks off and records programming of interest to their viewer(s) for viewing at any time.

Because television programming and system running costs are in many cases paid out of advertising revenue it is a critical issue to demonstrate a workable and desirable new business model or the new technology cannot be deployed. This metadata specification defines EPG schema format and language to carry Targeting control information from the program owners and/or distributors to influence the personal programming decisions made be the Intelligent Digital TV end-user system (or PDR) thus leading the way to acceptable business models for all system contributors.

Targeting

Introduction

Personal TV systems can function without program targeting but all personal programming decisions are then made totally independently by the software agents in the end-user equipment leaving out the potential for new business models for program makers, distributors and operators, brought about by communication to influence the agent's decisions.

The Targeting DS (T-DS) contains selection information which is in addition to the usual Program content and schedule information (ie EPG). T-DS references a program location or scheduled or broadcast program (event) and has information in two parts to select or influence selection of:

(1) Audience for the program and,

If successful Then execute:

(2) Presentation or display of the program.

T-DS, for example, enables program copyright owners, distributors and broadcasters to influence the selection of offered or available programs at the end-user equipment so they match their interests as well as the personal interests and preferences of the user. In addition an obvious use is for the audience targeting of advertisement programs (Ad's or commercials) but the same mechanism is used for personalized programming in general for influencing final production of personal programming and virtual channels. The following is an example of target information supported:

Audience targeting (audience selection) is based the following three main types of data:

User demographic information

name, age, sex, language, occupation, income, etc

Preference rated program information or other preference rated information (e.g. products),

distributor, producer, title, subject, genre-main, genre-sub, actor-1, actor2, etc

Transition behavior, using data monitored when changing TV programs,

changing between Titles, Genres and Channels.

General geographic, household, AVCE product or industry information

time-zone, ZIP/post-code, no. TV's, HomeNet, etc.

In addition each database row (or database item) is augmented with a confidence level value. This is particularly useful for automatically inferred data items or rows enabling information entries of useful value but with less than 100% confidence. Of course for manually entered data then confidence is 100%.

Presentation targeting (selection of when to show) is based on the following main types of data:

Time information;

actual or relative time of presentation

Another defined program event;

Insert, Substitute Rights, Repeat count

Money attribute with each term.

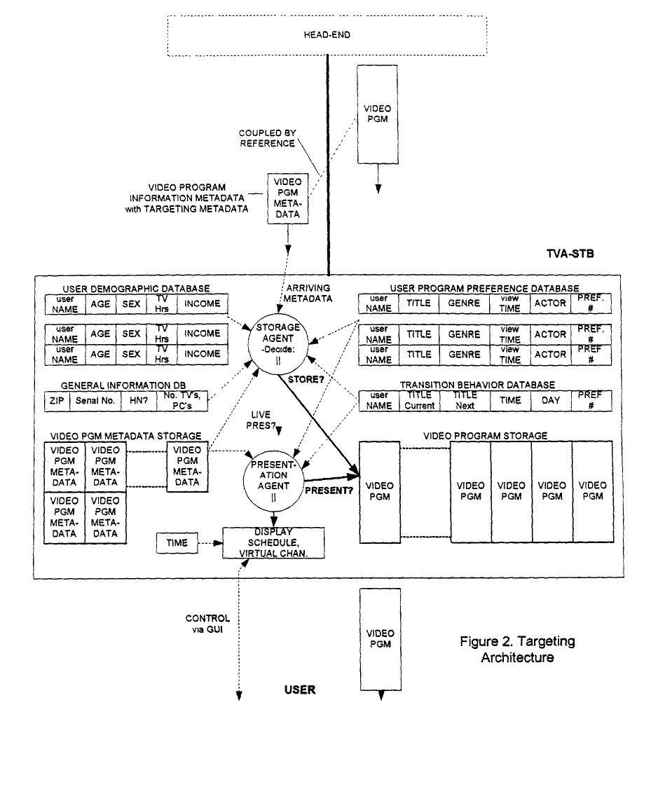

In a sense the broadcast T-DS information represents a simple ‘computer’ program of targeting instructions, interpreted by common agents each operating independently using special local user data in order to resolve the targeting (selection) decisions, see FIG. 2.

Audience targeting instructions are analyzed by the storage STB agent on arrival and entail comparing given targeting information against specially accessed local target information as specified in the targeting expression. If audience targeting is successful (ultimately a Yes or No decision) then the metadata (program and targeting) is stored locally and by so doing a note is made to store the program on arrival later (by seconds or days). This may require, at a scheduled time, a seeking of the program e.g. Analog and or digital TV tuner control or even Web access to access the program.

Targeting is by construction of a logical selection expression of information terms and the data content model used allows a flexible definition of target. The target can be made as narrow or wide as required and include a variety of types, traditional and new. A money attribute allows cost/revenue based (presentation) decision making in the event of multiple suitable program material competing for the viewers attention.

The subsections contain the specification of the syntax and semantics of the Targeting Description Schema, as well as some examples.

Targeting, Description and Resolution

Starting with a targeting example:

“Consider the audience target successfully found IF the targeting description ‘Most popular MainGenre of Movie is Action’ is True”.

Targeting is selecting a target by selecting a certain, user oriented data item, from a data set collected and retained by the end-user STB system, ie most popular one item of a certain category of items, and comparing it to a given data item. If the compare is successful then the Audience target is considered found. There a number of ways to custruct the data item selection part of the targeting.

One way is to have a two part selection statement. One part is a target information type definition (e.g. Genre: Movie.Action) and it is succeeded by the second part which is one from a set of defined and fixed selection qualifiers. Together they create a targeting question precise enough to be allow resolution as to whether the location user information offers the intended target for the program. If the answer is True then the audience target is considered successful. Examples of selection qualifiers:

TARGET-IS-THE-MOST-POPULAR,

CORRELATION-WITH-TARGET,

EXACTLY-DEFINED-BY-TARGET,

PREFERENCE-FOR-TARGET

HAS-INSTANCE-HISTORY-OF-TARGET,

HAS-INTEREST-HISTORY-OF-TARGET.

This works well for a small number of question types and where they are general in nature but for a large number of question types and where detailed unambiguous questions, flexibility and extendibility is required then the method isn't suitable.

An alternative way, type two, is rather than explicitly build in (to the metadata definition) a set of pre-determined selection qualifiers to make the targeting question, they can be created in a general way by considering that the STB target is in the form of a database, e.g. called: preferences, of known columns, e.g. channel, program, genre_main, genre_sub, preference_rating, with known possible labels or values for the database contents. The audience targeting question is now constructed in a general format using a standard database selection format, structured query language (SQL) query and the question. For example:

“Audience targeting successful IF (‘most popular item of a defined type from STB database’=‘given item’). This is a comparison of the database selection item result against the given item. Taking a further developed version of the example:

“Consider the audience targeting successful IF the most popular genre of ‘movie’ is ‘action’”. The database is searched for the name of the most popular Genre-Sub (e.g. with the highest count of Genre-Sub) for the Genre-Main of movie and the test made be comparing to see if the result equals the given Genre-sub name ‘action’.

Type one targeting description is constructed as follows:

IF(
TARGET(genre_sub ‘action’, genre_main ‘movie’) TARGET-IS-THE-
MOST-POPULAR
)?

Type two, (first version) targeting desciption is as

follows:
IF(
(SELECT genre_sub FROM preferences
WHERE genre_main =‘movie’
AND preference_rating = (SELECT MAX(preference_rating) FROM
preferences

WHERE genre_main = ‘movie’;)

;)
= ‘action’ )?

Type two targeting, though more complex, offers very precise targeting and avoids the ambiguity present in type one where it isn't stating clearly in the words that the intention is to use ratings to compare the most popular sub_genre of movie program and ignore all other programs. Also, there are a number of ways to determine ‘Most popular’. One way is to search for the highest preference rating for main-genre movie using two SELECT queries as shown above. Another way is for the database to be searched for sub-genre label of the highest count of sub-genre for the main-genre ‘movie’ as below:

Type two, (second version) of example targeting description, as follows:

IF(
(SELECT genre_sub FROM preferences
WHERE genre_main =‘movie’

GROUP BY genre_sub
HAVING MAX (COUNT(genre_sub))

;)
= ‘action’ )?

Regarding type 1 it would be difficult to think up in advance and make a fixed metadata ‘selection qualifier’ statement for every possible way to pick user target profile data for the targeting test question and also result in a less compact and more complex specification. Therefore type 2, targeting using standardised database selection statements (e.g. SQL), is favored for use over type 1.

Targeting using Database Selection

There are two types of database in the end-user equipment (STB).

The most obvious type is the program history data type. The program preferences database, with data mainly from monitoring programs viewed, is the main one of this type. Targeting access to this database enables, for example, the targeting of a user with a preference for a particular program or genre type of program or title or actor.

The second type of database contains data from monitoring user behavior for example regarding the transitions and switching between contexts e.g. programs and program content types like title, channel and genre. This type therefore brings additional target material for reaching user types through their monitored and processed behaviors.

One can for example write targeting instructions to reach a user who switches to Fox News after watching Larry King on Monday nights. The history type preferences database does not have this transition type data.

Database queries can be extended by joining e.g. Titles and accessing both program preferences and transition behavior databases.

Program Preferences database

The User information in each STB is held in relational databases. One of the databases is for user Demographic data, one for General information relating to the household as a whole, one is for program Transition behavior and another is called the program Preferences database.

The User demographic database has row entries for each user or predicted-user, predicted in the case that users declined to enter their personal information and the data has been automatically generated. Each row contains details like age, gender, race, occupation and a confidence rating number to give a measure of confidence in the automatically generated data. The common case of targeting an advertisement video to an age or age range target would require accessing the age data from the age column.

The General information database is typically a single row database with the following example column types: Geographic location (ZIP code, time-zone), PC's-in-house, Serial number. The Preference database consists of many rows of program history data of recently viewed video programs with important program content information (e.g. Title, Genre) user information and a preference rating. Non-program data is included in here if there is a preference rating attached e.g. products-UPC. The most-popular or most-preferred can be determined by examining the automatically pre-computed preference rating number or by counting instances as specified in the targeting instructions. Program preferences are based on the background monitoring of programs viewed and user control but entries can be also made directly to the database by the user via a GUI e.g. preference for an actor or program genre or subject.

Columns of this ‘Preferences’ database are given here as an example. For the full set see semantics table later:

PREFERENCE-RATING-FOR-ROW

SERVICE
CHANNEL-DISTRIBUTION

VIEW-START-TIME
VIEW-DAY-OF-WEEK

TITLE

KEYWORD

GENRE-MAIN
GENRE-SUB

MPAA-RATING
CAST1

CONFIDENCE-Level
(especially useful for
inferred entries)

A column for Preference Rating number is available for each row. This is a number e.g. between 100 and 999 indicating relative preference for the row item and may have been produce automatically, for example be preference agent, or entered manually. A Preference database row example follows:

```
500,  HBO,
DSS399,
    2100
    FRIDAY,
      INDEPENDENCE DAY,
        SIFT,  MOVIE,
          ACTION, G,  JOE BLOGGS, 90.
```

Sometimes complex targeting is required e.g. “Target Audience where most popular genre of movie is ACTION”, and this is done in a general way by including in the targeting metadata information a subset of the SQL (Structured Query Language) standard method to access a data item from the databases. The subset is use of only the ‘SELECT’ command and a version of it which only returns one result.

The result returned after a SELECT command, e.g. looking for the highest preference rating for MOVIE, is compared to the targeting item e.g. ACTION, to result in a logical TRUE or FALSE. The use of the SQL SELECT command is merely to use a standard way (ANSI) to describe a targeting item, as an alternative to re-inventing new words to do the same thing, and doesn't imply that an SQL database or SQL interface need be employed in a STB implementation.

### TARGETING EXAMPLE 1

Consider the audience targeting successful IF “Most popular GENRE of MOVIE is ACTION”.

```
IF(
SELECT genre_sub FROM preferences
          WHERE genre_main = ‘movie’
        AND rating = (SELECT MAX(rating) FROM preferences
                      WHERE genre_main = ‘movie’;) ;
) = ‘action’
```

### TARGETING EXAMPLE 2

Consider the audience targeting successful IF “MOVIE.ACTION is 90% more popular than the next most popular”

IF(
(SELECT MAX(rating) FROM preferences
WHERE genre_main = ‘movie’ AND genre_sub = ‘action’;)
/
(SELECT MAX(rating) FROM preferences
WHERE genre_main = ‘movie’ AND genre_sub != ‘action’;)
) = 1.9

### TARGETING EXAMPLE 3

Consider the audience targeting successful IF “Most popular DAY OF WEEK for watching MOVIE.ACTION is FRIDAY”

```
IF(
SELECT view_day_of_week FROM preferences
      WHERE genre_main = ‘movie’
AND genre_sub = ‘action’
GROUP BY view_day_of_week
      HAVING MAX ( COUNT (view_day_of_week));
)= ‘friday’
```

### TARGETING EXAMPLE 4

Consider the audience targeting successful IF “Most popular TIME for watching MOVIE.ACTION is 9:00PM”

IF(
SELECT view_start_time FROM preferences
WHERE genre_main = ‘movie’
AND genre_sub = ‘action’
AND view_day_of_week = ( SELECT view_day_of_week
FROM preferences

WHERE genre_main = ‘movie’
AND genre_sub = ‘action’
GROUP BY view_day_of_week
HAVING MAX
(COUNT(view_day_of_week)) ; )

GROUP BY view_start_time
HAVING MAX(COUNT(view_start_time));
) = 2100

Transition Behavior type database

This database contains data from user transition behavior history. Transition behavior in this sense is the user viewing a TV program and making a transition from a Present-state to a Next-state where the state transition is a decision point defined in time using absolute and relative time parameters ie time-of-day, time-of-week and transition time relative to the program start. The state is a program or program content defining parameter e.g. Title, Channel and Genre. The technique isn't however limited to these state parameters and works equally well for other behaviors for example the state types Subject and Actor.

A pre-computed preference rating is also added as a row data item. This is different for different state type transitions because not all state parameters need change at a transition point, for example, a transitions may be a Title change but stay with same Genre, or Title change and stay with same Channel.

Example columns for this database are given here:

USER NAME

CONFIDENCE-LEVEL

TITLE-CURRENT

TITLE-NEXT

TITLE-PREFERENCE-RATING

CHANNEL-CURRENT

CHANNEL-NEXT

CHANNEL-PREFERENCE-RATING

GENRE-CURRENT

GENRE-NEXT

GENRE-PREFERENCE-RATING

TRANS-DAY-OF-WEEK,

TRANS-TIME-OF-DAY,

TRANS-REL-TIME-IN-SESSION

TRANS-REL-TIME-IN-PROGRAM

### TARGETING EXAMPLE 5

Consider the audience targeting successful IF “Most likely Title following ‘Larry King’ on a Monday is ‘FOX News’”

The audience targeting question is to do with a Title transition so the audience targeting instruction is directed at the Transition behavior database rather than the program Preferences database.

```
IF(
SELECT title-next FROM transition
WHERE trans-day-of-week = ‘monday’
AND title-current = ‘Larry King’
AND title-preference-rating = (SELECT MAX (title-preference-
rating) FROM transition
                  WHERE trans-day-of-week = ‘monday’
                  AND title-current = ‘Larry King’;)
)=‘FOX News’
```

Targeting Architecture

Architecture Overall Description

Special targeting information is added to or supplements the program information metadata to enable the video program it references, to be aimed at a user target. The target is described by data in the end-user equipment (STB or PDR) and consists of for example user demographics or user program preferences see, FIG. 2.

FIG. 2 is a block diagram of the basic targeting architecture. It shows video programs and associated metadata being broadcast from the TV distribution plant and an exploded view of relevant agent and database modules in the end-user equipment e.g. Set-Top Box.

The two bubbles in the STB represent software controller agents. The upper one, called storage agent, is responsible for deciding whether an arriving metadata, and later arriving video program, should be stored or not. The lower one, presentation agent, is responsible for deciding, what programs to show or present to the user at what time, it's decision output being a Virtual Channel in the electronic program guide (EPG). Arrow lines pointing at each agent indicate data from stored information used to make the decision and is represented in the FIG. 2 as four databases: demographics, preferences, general and the stored metadata database.

Upper right is the User Program Preference database. This contains a table of data, each row for example derived from user TV viewing history, about Programs watched and some of their content description information e.g. Title, Genre, Actor, together with a preference rating number indicating relative preference. The Preference Rating (pre-computed and derived from local user data) is a positive integer number where higher indicates more relative preference and highest indicates the favorite item. Row data of a non-program type can also be input by the user directly for example to indicate strong preference for a particular actor or director. In any case all elements of each row need not be filled. Generalized content and individual information can be obtained by querying this database.

Upper left is the User Demographic database. This contains personal data about the user or users and may be have been obtained by direct user input OR inferred by programs viewed and cross-correlated to demographics (production of which is not part of this specification). Household aggregate and individual information may be obtained by querying this database.

Center left is a small database of General Information for useful target data that does not fit in with User demographic or Program e.g. STB geographic location, Serial number, Presence of TV's, PC's etc.

Lower left is the storage area for program Metadata that is either pending actual program material or corresponding to actual stored Programs shown in the area lower right.

Virtual Channel

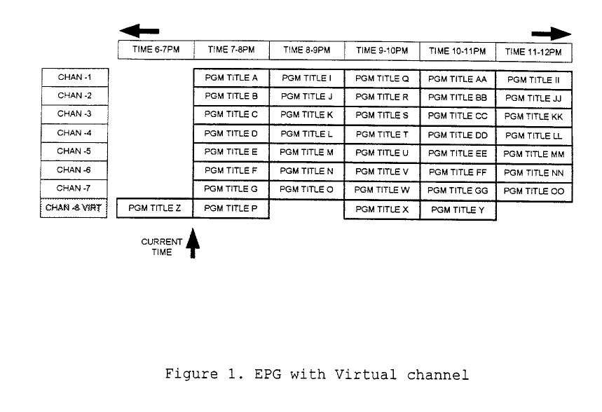

As can be seen from FIG. 1 the virtual channel appears in the EPG schedule and looks just a regular, live, TV channel with certain programs scheduled to be shown at certain times of the day. The obvious difference, and this may be transparent to the user, is that it is made using previously stored programs (channel 8 in FIG. 1, programs Z, P, X and Y) and plays out from the STB (PDR) video storage (hard-drive).

The user will find that, unlike regular scheduled programming, he can go back in time (e.g. 6-7PM) and watch programs scheduled in the virtual channel for earlier in the day (Program Z). When doing this, of course, regular programming in the program guide is blanked out or marked as unavailable. Also, the system agents know when the user never watches TV e.g. see FIG. 1, 8-9PM out of the house, or 11PM onwards in bed, both always have the STB/TV switched off, so there is normally no virtual channel scheduled program for these times. User request via a GUI button feature command can instruct the system to complete fully the V.Ch. schedule e.g. for the remainder of the day.

All virtual channel programs are audience targeted and user preferred programs. A virtual channel schedule is considered more natural for use than to offer a completely separate mechanism (e.g. top ten list presentation), because a user HAS to interact with as an EPG schedule for all live programs, and it makes sense to see the selected user preferred programs alongside the live programming in the guide schedule.

Storage Agent

Arriving metadata, arriving before the associated video program, is examined by this controlling agent for presence of audience targeting information. If present it is processed using local target database items and if successful the metadata is stored and also the associated video program is stored on later arrival. Target databases are User demographics, User program preferences and General information. and also metadata indicating programs already stored. Storage agent tasks are listed:

Examine incoming metadata and save successful metadata;

Manage stored metadata for example read saved metadata and access and save the associated programs. At any one time there might be a number of solo metadata blocks of information pending arrival or access of the associated program material. The storage agent manages control data in addition to the metadata and program to enable effective system operation. This control data is for a directory of metadata and programs and also includes control data elements (bits, bytes) to account for the presence of and usage of the programs e.g. presentation counts.

Housekeep metadata and program storage areas. That is Observe and Delete: (1) expired programs, (2) presented programs (3) completed campaigns for each program ie number of presentation repeats satisfied (4) if short of storage capacity then re-process targeting and delete programs that produce a relatively weak targeting success factor in favor of keeping or saving the stronger. The targeting success factor (instead of straight Yes or No) is used for housekeeping metadata where there is uncertainty about inferred local target data (see appendix). Here, for example, users have not input their demographics directly so they are inferred using additional agents and input data (not described here). The inference process is dynamic and can change the probability of set user demographic profiles or add or remove profiles. Therefore depending on the audience targeting expression and certainty of local data, the targeting result could be a value (between yes-1 and no-0) and be different from a few days prior. The housekeeping software re-assesses targeting success as needed for the purpose of deleting or replace stored programs.

Arriving material for live presentation can short circuit the described process (storing metadata, storing program) as the presentation agent can be notified directly.

Audience targeting depends on three things:

(1) Metadata targeting instructions;

(2) Processing agent algorithm including some built-in rules;

(3) Local target data.

Certain targeting rules are built in to the processing agent e.g. whether to store a program in the event of a space limitation., whether to store a program with audience targeting successful but which doesn't seem to match user preferences. Modules of this processing agent (storage agent) e.g. targeting module, can normally be updated or replaced to enable a different interpretation of targeting metadata and local data.

Presentation Agent

The presentation agent has the basic task of making a program schedule for the audience selected and stored regular preferred programs (ie audience targeted or otherwise captured programs) for their notification to the user (in the multi-user case to the current user), see FIG. 2. In addition to regular programs the presentation agent has to identify and present advertising programs (Ad's). Audience targeted Ad's are placed between programs and inserted or substituted within programs as the defined rights and other metadata allow.

For regular programs the preferred notification format is to make up one (or more if need be for different users or extra content) personal virtual channels for the displayed program guide so the stored programs can be displayed alongside live scheduled programs. On the face of it as these programs are from storage they could be listed in order of preference rating with the highest number first. However, this does not permit proper notification of them to the user who must use an EPG (electoronic program guide) for all live scheduled programs nor does it permit ordering them suitable for the viewing time.

The user has the choice whether to select and stay on the virtual (personal) channel or switch to live or other programming. If the user stays on the virtual channel then programs are automatically replayed sequentally from storage as per the created schedule.

The presentation agent determines how to make the personal channel programming (personal final production) using the following information:

(1) targeting metadata including business ID's and money values;

(2) user program preferences and transition behavior databases;

(3) presentation agent algorithm with presentation and conflict resolution rules;

(4) global (applying to all commercials) business rules (and downloaded to user boxes).

The T-DS presentation content model options allow either Time information or another Program (location information) to be used to set placement targets e.g. setting a specific time for presentation or in the case of a commercial, setting another specific program to present before, after or within as a insertion or substitute for another commercial. A strength attribute is included in the metadata to be used by the agent in the decision process. Taking an example if the strength is “EXACTLY-DEFINED-BY-TARGET” for a ‘Given Target Program Location’ and the program isn't found within the operation period then the program is discarded even if the audience target was satisfactory. On the other hand if the strength is ““BEST-EFFORT” then a similar program is chosen for presentation.

### Operation of the Presentation Agent Virtual-Channel Creation Algorithm

The presentation agent determines how to make the personal channel programming using the local data and presentation metadata. It is possible for the local data and metadata to suggest different programs for each time slot of the virtual channel and these conflicts are resolved by the agent. Broad plan of agent operation is as follows:

(1) Time slot by time slot the algorithm makes a hidden-for-internal-working virtual channel using the presentation metadata resolving conflicts using a downloaded rules set (e.g. giving preference to a particular business ID),

(2) Time slot by time slot the algorithm accesses program preferences from the preference database and makes another hidden-for-internal-working virtual channel,

(3) Then the agent makes up the actual virtual channel taking input from both hidden-for-internal-working virtual channels.

Sometimes there are multiple programs vying for the same presentation time. In this case the money attribute can be used to decide which program to present. At some other times there are multiple programs vying for the same presentation time and in the Rights and ID metadata is used in conduction with downloaded special rules (not shown on diagrams) to enable the decision about what to present or recommend in the personal channel program guide. These rules may indicate (for business reasons) that presentation should be biased to favor programs belonging to a certain ID over those from another ID.

Targeting DS

Definition

Target Expression allows definition of an audience target. Terms, number of terms and logic operators are chosen to make the desired target narrow or wide, simple or complex. One or more Money attributes are optionally added to further assist the selection decision. The Cost amount is either positive (e.g. for movie) or negative (e.g. for a advertising). Computational Precedence NOT, AND, OR

[image]

[image]

[image]

[image]

[image]

[image]

[image]

[image]

[image]

[image]

[image]

[image]

[image]

[image]

[image]

[image]

[image]

[image]

| Name | Definition |
|---|---|
| TargetingInformation | Metadata content model to accompany or |
| Type | precede a program. Enables program |
| | copyright owners and distributors to |
| | influence the personalized programming |
| | and program stream production decisions |
| | at the end-user equipment. |
| OperatingPeriod | Program with this metadata should be used |
| | only during the period. Defined by Open |
| | (date) and Close (date). |
| ProgramLocation, | Defines the Program that the Targeting |
| ProgramLocationType | pertains to. References the TVA |
| | ProgramLocationType including Broadcast |
| | Services and the Web. |
| — | — |
| BusinessIDs, | Set of business ID's intended to allow |
| BusinessIDsType | proper accounting for programs selected. |
| | Copyright owner ID, Agency Service ID, |
| | Distribution Service ID, Targeting |
| | Service ID, Unnamed ID |
| CopyrightOwnerID | Copyright owner identity of video program |
| | material. |
| AgencyServiceID | Agency services identity, if any |
| | involved, e.g. Advertising Agency. This |
| | may be needed to automatically apportion |
| | payments at the end of a certain |
| | accounting period e.g. audience |
| | monitoring period. |
| | Distribution service identity e.g. TV |
| DistributionService ID | Company, Cable company, Internet company |
| | etc. |
| TargetingServiceID | Targeting services company, if different |
| | identity, managing the system operation |
| | e.g. target program scheduling, metadata |
| | and audience measurement. |
| UnnamedID | Any other company identity fiscally |
| | relevant to the system operation. |
| — | — |
| ProductionRights | Set of rights governing the permitted |
| | usage of, and usage by others of, this |
| | particular video program regarding |
| | insertion, substitution, and repeat use. |
| — | — |
| RepeatControl, | Data governing repeats: Maximum number of |
| RepeatControlType | repeats, Minimum and Maximum time |
| | interval between repeats. |
| NumberMaximum | Maximum number of permitted presentations |
| | of this video program. |
| IntervalMinimum | Minimum time interval between repeat |
| | showings of the video program. Absolute |
| | minimum permitted interval even if the |
| | targeting expression allows a smaller |
| | interval. |
| IntervalMaximum | Maximum time interval between repeat |
| | showings of the video program. Absolute |
| | maximum permitted interval even if the |
| | targeting expression allows a smaller |
| | interval. |
| — | — |
| IFAudienceTargetTrue | The first, IF or ‘arming’ part of a IF- |
| | THEN-ELSE statement governs the |
| | AUDIENCE selection for the |
| | pertaining video |
| | material or program and determines |
| | whether it is a candidate for |
| | presentation. Decision is from the |
| | boolean results of compare(s) OF an item |
| | selected from the STB target database TO |
| | the targeting item string or integer |
| | value. |
| — | — |
| THENSeekPresentation- | This ‘THEN-PRESENTATION’ expression is |
| Target | the second part of the targeting IF-THEN- |
| | ELSE statement and selects the |
| | presentation and production for the |
| | pertaining video material or program. It |
| | determines when, how or with what other |
| | program this program material should be |
| | shown. |
| | Element may be repeated for multiple |
| | Presentation targets. |
| — | — |
| ELSETargeting- | The ACTION attributes govern what to do |
| Unsuccessful, | with the video program should any of the |
| ELSETargeting- | targeting be unsuccessful. |
| UnsuccessfulType | |
| ACTION | NO-OP |
| | IGNORE/DELETE-PROGRAM |
| (TargetsUnSuccessful | FETCH/KEEP-PROGRAM |
| attribute) | FETCH/KEEP-PROGRAM-RETRY |
| — | — |
| ProductionRightsType | Sub-level content model defining the |
| | permissions (Unrestricted or Prohibited) |
| | for usage of, and usage by others of, |
| | this particular video program (segment or |
| | material) regarding insertion, |
| | substitution, and repeat use. |
| InsertionWithinSelf | Regarding another video program inserted |
| | within this program |
| ToBeAnInsert | Regarding this program being inserted in |
| | another program |
| SubstitutionWithinS | Regarding another video program |
| elf | substituted for part of this program |
| ToBeASubstitute | Regarding this video program being a |
| | substitute for part of another program |
| OneTimeUse | Regarding this program being used once |
| RepeatUse | Regarding this program being used |
| | multiple times |
| IFAudienceTarget- | Logical expression (with result True or |
| TrueType | False) provides for the definition of an |
| | audience target for the video program, |
| | segment or material. The target is made |
| | narrow or wide using one or multiple |
| | terms and logic operators*. |
| | Each term is itself a conditional IF- |
| | expression (result True or False) after |
| | comparing an Item from the Target STB |
| | information databases of program |
| | preferences, program content information |
| | or general items to a given Item. |
| | Items are pulled from the STB information |
| | databases using an SQL (relational |
| | database) query -a general way to look |
| | for most popular program, most frequently |
| | viewed genre, most popluar time etc of |
| | any item. |
| | *Expression evaluation is in the order |
| | NOT, AND, OR. |
| FirstTermIFStatement | Definition of Audience targeting |
| | question. First term IF statement |
| | consisting of: |
| | (IF(SelectedTargetItem, CompareOperator, |
| | GivenTargetingItem) = TRUE), targeting |
| Name | Definition |
| | is deemed successful. |
| | Selected Target Items is a choice as |
| | follows: |
| | DatabaseItem or |
| | DatabaseExpression (an expression of two |
| | regular database items) |
| | Target is made narrow or wide using one |
| | or multiple terms and logic operators*. |
| Logical | Operator (only NOT type) optionally used |
| | for the first term. |
| DatabaseItem | Selected target information Item is |
| SQLDatabaseType | described by an industry standardized SQL |
| | database query for the Item from a choice |
| | of STB target databases as follows: |
| | Preferences, |
| | Transition, |
| | Demographic, |
| | GeneralInfo, |
| | ProprietaryInfo. |
| DatabaseExpressionR | Choice of target item which is derived |
| esultItemResultItem | from an expression of two or more |
| | selected database Item items joined by |
| | the ExpressionOperator. |
| DatabaseExpressionR | DatabaseItem(1), Expression Operator, |
| esultItemResultItem | DatabaseItem(2). |
| Type | |
| ExpressionOperator | Fixed choice of operator from: |
| | EQ—Equal |
| | NE—Not Equal |
| | LT—Less Than |
| | LE—Less than or Equal to |
| | GT—Greater Than |
| | GE—Greater than or Equal to |
| | PLUS—arithmetic |
| | SUBTRACT—arithmetic |
| | MULTIPLY—arithmetic |
| | DIVIDEDBY—arithmetic |
| | AND—Logical AND of neighboring terms; |
| | ANDNOT—Negate next term then logical |
| | AND of neighboring terms.). AND |
| | is performed after all NOT's. |
| | OR—Logical OR of neighboring terms (or |
| | groups of AND'd terms). OR is performed |
| | after all AND's and NOT's. |
| | ORNOT—Negate next term then logical OR |
| | of neighboring terms (or groups of AND'd |
| | terms). OR is performed after all AND's |
| | and NOT's. |
| | XOR—Exclusive OR |
| | XNOR—Exclusive NOR. |
| — | — |
| CompareOperator | Compare logic operator to implement the |
| | compare of the first ‘Choice’ item |
| | (target item) from a STB database and the |
| | given targeting item. |
| CompareOperatorType | Conditional compare types as follows: |
| | EQ—Equal |
| | NE—Not Equal |
| | LIKE—Like (using % for missing letters) |
| | LT—Less Than |
| | LE—Less than or Equal to |
| | GT—Greater Than |
| | GE—Greater than or Equal to |
| | EQWIN02—Equal, approximation within 2% |
| | accepted |
| | EQWIN05—Equal, approximation within 5% |
| | accepted |
| | EQWIN10—Equal, approximation within 10% |
| | accepted |
| | MATCHGT10FWORDS |
| | MATCHGT20FWORDS |
| | MATCHGT30FWORDS |
| | MATCHGT50PCOFWORDS |
| | MATCHGT75PCOFWORDS |
| | MATCHGT90PCOFWORDS |
| GivenItems | One Given targeting item (Integer or |
| | String) or |
| | Logical expression of Given targeting |
| | items joined by logic operators for |
| | example AND, OR. Multiple items are |
| | considered bracketed regarding the |
| | compare operator. |
| Integer | Given Integer item to compare against |
| String | Given Text item to compare against |
| | Can include ‘TRUE’ and ‘FALSE’ |
| LogicOperatorType | See LogicOperatorType |
| ExtraTermIFStatement | Additional term IF statement consisting |
| | of: |
| | LogicOperator( |
| | IF(SelectedTargetItem, CompareOperator, |
| | GivenTargetingItem) = TRUE ), targeting |
| | is deemed successful. |
| | SelectedTargetItem is selected |
| | information from a choice of STB target |
| | databases. Target is made narrow or wide |
| | using one or multiple terms and logic |
| | operators*. |
| LogicOperator | Fixed choice of term join operator from: |
| | AND, ANDNOT, OR, ORNOT, XOR, XNOR. |
| | *Expression evaluation is in the order |
| | NOT, AND, OR, XOR. |
| LogicOperatorType | Fixed choice of expression logical |
| | operator from: |
| | AND—Logical AND of neighboring terms; |
| | ANDNOT—Negate next term then logical |
| | AND of neighboring terms.). AND is |
| | performed after all NOT's. |
| | OR—Logical OR of neighboring terms (or |
| | groups of AND'd terms). OR is performed |
| | after all AND's and NOT's. |
| | ORNOT—Negate next term then logical OR |
| | of neighboring terms (or groups of AND'd |
| | terms). OR is performed after all AND's |
| | and NOT's. |
| | XOR—Exclusive OR |
| | XNOR—Exclusive NOR. |
| — | — |
| Preferences | Choice of target items from ‘preferences’ |
| | database of user program viewing history |
| | including manually entered items and |
| | other items e.g. products - all items in |
| | this database have a preference rating |
| | value. Column examples are: |
| | USER-NAME |
| | PREFERENCE-RATING-FOR-ROW (integer) |
| | SERVICE |
| | CHANNEL-DISTRIBUTION |
| | VIEW-START-TIME |
| | VIEW-END-TIME |
| | VIEW-DAY-OF-WEEK |
| | TITLE |
| | KEYWORD |
| | LANGUAGE |
| | GENRE-MAIN |
| | GENRE-SUB |
| | REVIEW-RATING (integer) |
| | SUBJECT-1 |
| | SUBJECT-2 |
| | MPAA-RATING |
| | CAST-1 |
| | CAST-2 |
| | CAST-3 |
| | OTHER-PRODUCT-NAICS |
| | OTHER-PRODUCT-UPC |
| | CONFIDENCE LEVEL (especially useful for |
| | inferred entries) |
| | OTHER? |
| SQLQuery | SQL query text string. Example text |
| (Preferences | string: |
| attribute) | ‘SELECT genre_sub |
| | FROM preferences WHERE |
| | genre_main = ‘movie’ AND rating = |
| | (SELECT MAX(rating) FROM preferences |
| | WHERE genre_main = ‘movie’;);’ |
| — | — |
| Transition | Choice of target items from the |
| | ‘transition’ database of user behavior |
| | regarding changing from one Title to |
| | another or One Genre to another. Column |
| | examples are: |
| | USER NAME |
| | CONFIDENCE-LEVEL |
| | (useful for inferred User Name entry) |
| | TITLE-CURRENT |
| | TITLE-NEXT |
| | TITLE-PREFERENCE-RATING |
| | CHANNEL-CURRENT |
| | CHANNEL-NEXT |
| | CHANNEL-PREFERENCE-RATING |
| | GENRE-CURRENT |
| | GENRE-NEXT |
| | GENRE-PREFERENCE-RATING |
| | TRANS-DAY-OF-WEEK, |
| | TRANS-TIME-OF-DAY, |
| | TRANS-REL-TIME-IN-SESSION |
| | TRANS-REL-TIME-IN-PROGRAM |
| SQLQuery | SQL query text string. |
| (Transition | |
| attribute) | |
| — | — |
| Demographic | Choice of target item from ‘demographic’ |
| | database of the user(s). May be manually |
| | entered or inferred or both. Column |
| | examples are: |
| | USER-NAME |
| | AGE |
| | RACE |
| | INCOME |
| | LANGUAGE |
| | EDUCATION |
| | OCCUPATION |
| | OCCUPATION-NAICS |
| | TVHOURS-AVE-PER-WEEK |
| | CONFIDENCE LEVEL (re: information in e.g. |
| | ROW entry; e.g. allows 2 or more row |
| | entries for one user) |
| | OTHER? |
| SQLQuery | SQL query text string. Example text |
| (Demographic | string: |
| attribute) | ‘SELECT max(age) FROM |
| | demographic WHERE |
| | sex = ‘male’ AND occupation != student;’ |
| — | — |
| GeneralInfo | Choice of target item from ‘generalinfo’ |
| | database of general information. May be |
| | manually entered or inferred or both. |
| | Includes location information, serial |
| | numbers. Column examples are: |
| | GEO-COUNTRY |
| | GEO-TIME-ZONE-TERRITORY |
| | GEO-ZIP-CODE-(USA) |
| | BOX-SERIAL-NO |
| | BOX-RANDOM-FIXED-NO |
| | TECH-TVSETS-NO |
| | TECH-VCRS-NO |
| | TECH-PCS-NO |
| | TECH-SERVICES-IN-USE |
| | PETS-NO |
| | CONFIDENCE LEVEL (re: information in e.g. |
| | ROW entry) |
| | OTHER? |
| SQLQuery | SQL query text string. Example text |
| Name | Definition |
| (GeneralInfo | string: |
| attribute) | ‘SELECT geo-zip-code-(usa) from |
| | generalinfo’ |
| — | — |
| ProprietaryInfo | Allows operator specific and non-standard |
| | extensions of the target expression. Care |
| | should be used as some systems will not |
| | be able to respond. Allows introduction |
| | of different proprietary complex type ie |
| | data content model |
| — | — |
| Name | Definition |
| THENSeekPresentation- | Logical expression (result True or False) |
| TargetType | provides for the definition of an |
| | presentation target for the video |
| | program, segment or material. |
| | The target is made narrow or wide using |
| | one or multiple terms and logic |
| | operators*. |
| | Presentation is either at a defined time |
| | using a temporal term or at a time based |
| | on program information or program |
| | location e.g. schedule information or can |
| | be a combination of above. |
| | *Expression evaluation is in the order |
| | NOT, AND, OR. |
| FirstTerm | Content model for the first term |
| | consisting of: |
| | Logical, then choice of Temporal Control |
| | Information or a Program Information type |
| | Presentation targeting. |
| | Includes a MONEYCOSTUSD attribute for |
| | valuing presentation terms. |
| | Includes a STRENGTH attribute qualifying |
| | how to present if the term is successful. |
| MoneyCostUSD | Video programs all have different costs |
| (attribute) | e.g. some are zero cost, a regular |
| | program or movie a certain positive cost |
| | and advertising program (commercial) a |
| | small negative cost (a credit). Money |
| | allows the end-user equipment to make an |
| | presentation selection decision that |
| | includes money value. |
| STRENGTH | Allowed attributes below define how the |
| (attribute) | associated term should be used: |
| | EXACTLY-DEFINED-BY-TERM |
| | BEST-EFFORT-DEFINED-BY-TERM |
| | ALTERNATIVE-TO-TERM-PERMITTED |
| | CONTINUE |
| | Example: |
| | (Exactly defined by) PgmGenre AND (Best- |
| | Effort defined by) Time |
| Logical | Operator (NOT) optionally used for the |
| | first term. |
| ExtraTerm | Content model for the first term |
| | consisting of: |
| | Logical, then choice of Temporal Control |
| | Information or a Program Information type |
| | Presentation targeting. |
| | Includes a MONEYCOSTUSD attribute for |
| | valuing presentation terms. |
| | Includes a STRENGTH attribute qualifying |
| | how to present if the term is successful. |
| LogicOperator, | Fixed choice of term join operator from: |
| LogicOperatorType | AND, ANDNOT, OR, ORNOT, XOR, XNOR. |
| | *Expression evaluation is in the order |
| | NOT, AND, OR, XOR. |
| — | — |
| TemporalControlInfo | Sub-level content model for setting a |
| rmation, | particular usage time or times for the |
| TemporalControlInfo | program (Presentation). Includes |
| rmationType | recurring day of week, recurring time of |
| | day, exact time span and also relative |
| | position for inserts and substitutions. |
| RecurringDay | Use program on a particular day of the |
| | week e.g. any Friday |
| RecurringTime | Start program at a particular time of the |
| | day e.g. 1900 hours any day. |
| DateTimeSpan | Exact start and end times and dates for |
| | use of the Program. |
| InsertBeforeprogram | Insertion of this EPG's program or video |
| Start | material before the start of the program |
| | referred to here. (Presentation target |
| | only) |
| InsertTimeFromProgr | Insertion of this EPG's program or video |
| amStart | material at this time after the start of |
| | the program referred to here. |
| | (Presentation target only) |
| InsertAfterProgramE | Insertion of this EPG's program or video |
| nd | material after the end of the program |
| | referred to here. |
| SubstituteTimeFromP | Substitution of this EPG's program or |
| rogramStart | video material at this time after the |
| | start of the program referred to here. |
| — | — |
| ProgramLocation, | In Presentation choice model this allows |
| ProgramLocationType | selection of a particular program for |
| | presentation (e.g. insert, before or |
| | after) OR a particular time or |
| | combination. References the TVA |
| | ProgramLocationType including Broadcast |
| | Services and the Web.and Program Content |
| | model definitions. |
| | Although defined for the program |
| | information entering the STB or PDR, this |
| | is assumed to be still applicable as |
| | targeting information (ie retained in the |
| | STB in a suitable form for this |
| | targeting). |
| GeneralInfo | GeneralInfo database example items: |
| database columns | |
| Geo-Country | Location of STB (country): |
| | USA |
| | UK |
| | etc |
| Geo-Time-Zone- | Location of STB (time-zone territory): |
| Territory | Eastern |
| | Central |
| | Mountain |
| | Pacific |
| | SouthEastern |
| | SouthCentral |
| | SouthMountain |
| | SouthPacific |
| | NorthEastern |
| | NorthCentral |
| | NorthMountain |
| | NorthPacific |
| Geo-ZIP-Ccode-(USA) | US postal ZIP code integer for small |
| | geographic area location (integer) |
| Box-Serial-No | End-user equipment (STB, PDR) Serial |
| | number. Arithemtic manipulation enables |
| | targeting for example a percentage of |
| | total population of STB's |
| Box-Random-Fixed-No | Fixed number now fixed but originally |
| | once generated by random technique. |
| | Arithmetic manipulation enables targeting |
| | for example a percentage of total |
| | population of STB's |
| Tech-TV-Set's-No | Integer number of TV sets at location |
| Tech-VCR-No | Integer number of VCR's at location |
| Tech-PCs-No | Integer number of PC's at location |
| Tech-Sevices-In-Use | Services in use at location: |
| | TVSatellite |
| | TVCable |
| | InternetDialUp |
| | InternetBroadband |
| | HomeNetwork1394 |
| | HomeNetworkEIA7751 |
| | HomeNetworkEthernet |
| Pets-No | Integer number of Pet's at location |
| Confidence Level | Confidence Level (percentage) for row |
| | entry particularly useful for marking |
| | inferred data entries which have a lower |
| | number than manually enterred information |
| | (which has maximum number). |
| | Allows there to be a number of entries |
| | for this general profile each with |
| | different confidence levels. |
| Other | |
| Demographic | Demographic Info database example items: |
| database | |
| Columns | |
| User Name | String for user name |
| Age | Integer defining user age |
| Race | Selected few race categories (others |
| | should be added): |
| | White, Black, Indian Continent, Asian |
| | Pacific Islander, Hispanic |
| Income | Individual viewer income as salary, |
| | integer. |
| Language | Selected language categories (others |
| | should be added): |
| | English, Mandarin, Cantonese, Vietnamese, |
| | Spanish, French. |
| Education | Selected education categories including: |
| | None, Grade-school, High-school, College, |
| | Graduate, Postgraduate. |
| Occupation | Selected occupation categories including: |
| | Not-working, Blue-collar and |
| | Professional-managerial. |
| Occupation-NAICS | Integer NAICS code for occupation. NAICS: |
| | North American Industry Classification |
| | System code number |
| TVHours-Ave-Per- | Integer computed from TV viewing history |
| Week | |
| Confidence Level | Confidence Level (percentage) for row |
| | entry particularly useful for marking |
| | inferred data entries which have a lower |
| | number than manually enterred information |
| | (which has maximum number). |
| | Allows there to be a number of user |
| | entries (for perhaps only one user) each |
| | with different confidence levels. |
| Other | |
| Preferences | Preferences database example items: |
| database | |
| Columns | |
| User Name | String for user name |
| PREFERENCE- | Integer (e.g. between 100 and 999) |
| RATING-FOR- | expressing a relative preference for the |
| ROW (integer) | row item (e.g. Program Genre) |
| Service | TV distribution service e.g. CNN, |
| | BECAmerica |
| Channel- | DSS-202, DSS-264 |
| Distribution | |
| View-Start-Time | 2100 |
| View-End-Time | 2130 |
| View-Day-Of-Week | Friday |
| Title | Independence Day |
| Keyword | Independence |
| Language | English |
| Genre-Main | Movie |
| Genre-Sub | Action |
| Review-Rating | 900 (e.g. between 100 and 999) |
| (integer) | |
| Subject-1 | Fiction |
| Subject-2 | Science Fiction Movie |
| MPAA-Rating | PG-13 |
| Cast-1 | Will Smith |
| Cast-2 | Mary McDonnell |
| Cast-3 | Jeff Goldblum |
| Other-Product-NAICS | Integer NAICS code for row: |
| | North American Industry Classification |
| | System code number |
| Other-Product-UPC | Universal Product Code Number |
| Confidence-Level | 50 especially useful |
| | Confidence level percentage integer. |
| | for inferred Example 50% would |
| | indicate the movie |
| | entries wasn't viewed fully or |
| | that the system |
| | was unsure of the user watching. |
| Other | |
| Transition database | Transition database example items: |
| columns | |
| USER NAME | String for user name |
| Confidence Level | Confidence Level (percentage) for row |
| | entry particularly useful for marking |
| | inferred data entries which have a lower |
| | number than manually enterred information |
| | (which has maximum number). |
| | Allows there to be a number of entries |
| | for this general profile each with |
| | different confidence levels. |
| TITLE-CURRENT | Title before transition (Title change) |
| TITLE-NEXT | Title after transition (Title change) |
| TITLE-PREFERENCE- | Computed preference rating for Title |
| RATING | transition |
| CHANNEL-CURRENT | Channel before transition (Channel |
| | change) |
| CHANNEL-NEXT | Channel after transition (Channel change) |
| CHANNEL- | Computed preference rating for Channel |
| PREFERENCE- | transition |
| RATING | |
| GENRE-CURRENT | Genre before transition (Genre change) |
| GENRE-NEXT | Genre after transition (Genre change) |
| GENRE-PREFERENCE- | Computed preference rating for Genre |
| RATING | transition |
| TRANS-DAY-OF- | Transition Day of the Week |
| WEEK, | (Sunday-Saturday) |
| TRANS-TIME- | Transition Time of Day (24 hour clock) |
| OF-DAY, | |
| TRANS-REL-TIME-IN- | Transition relative time after the user |
| SESSION | started watching TV that period |
| TRANS-REL-TIME-IN- | Transition time after start of program |
| PROGRAM | |
| — | — |

Targeting and Program Information Examples

Example with Targeting information for Audience and Presentation Targeting.

The following targeting metadata example is attached (by ProgramLocation reference) to an Advertising (Ad) video program and defines intended audience and presentation. The Ad program information is not described.

The targeted Audience is a weekday viewer, male age over 30, income over 50,000 also qualified by kids in the household. For end-user systems where the audience criteria is satisfied then presentation parameters are employed. For presentation this example targets:

Either Weekdays, 6-8PM, for an insertion into a program defined by Program-Location-Information, 5 minutes 30 seconds from the beginning Or at other times a Situation Comedy main Genre by the same video distribution service company as the Ad ie TV Company (TVCo-Mnop). The first target is preferred and comes with an impression credit amount of $0.005 and the second, more inferior, presentation $0.0001.

If the targets are not satisfied then this Ad program is ignored.

<TargetingInformation>
<OperatingPeriod Open=“2001-01-01” Close=“2001-2-14”/>
<ProgramLocation>

...reference to Ad video program...

</ProgramLocation>
<BusinessIDs>

<AgencyServiceID>

id.teveadagency.com/id01234

</AgencyServiceID>
<TargetingServiceID>

id.tvatargeting.com/id56789

</TargetingServiceID>

</BusinessIDs>
<ProductionRights>

<InsertionWithinSelf Right=“Prohibited”/>
<ToBeAnInsert Right=“Unrestricted”/>
<SubstitutionWithinSelf Right=“Prohibited”/>
<ToBeASubstitute Right=“Unrestricted”/>
<OneTimeUse Right=“Unrestricted”/>
<RepeatUse Right=“Unrestricted”/>

</ProductionRights>
<RepeatControl>

<NumberMaximum>3</NumberMaximum>
<IntervalMimimum>PT2H30M</IntervalMimimum>

</RepeatControl>
<IFAudienceTargetTrue>

<FirstTermIFStatement>

<PreferencesItem SQLQueryPreferences=

“SELECT view_day_of_week FROM
preferences GROUP BY
view_day_of_week HAVING MAX
( COUNT (view_day_of_week));”/>

<CompareOperator>NE</CompareOperator>
<GivenItems>

<String>“Saturday”</String>
<LogicalOperator>OR</LogicalOperator>
<String>“Sunday”</String>

</GivenItems>

</FirstTermIFStatement>
<ExtraTermIFStatement>

<LogicOperator>AND</LogicOperator>
<DemographicItem SQLQueryDemographic=

“SELECT income FROM demographic WHERE
sex = ‘male’ AND age >=
30”/>

<CompareOperator>GT</CompareOperator>
<GivenItems>

<Integer>50000</Integer>

</ExtraTermIFStatement>
<ExtraTermIFStatement>

<LogicOperator>AND</LogicOperator>
<DemographicItem SQLQueryDemographic=

“SELECT COUNT(name) FROM demographic
GROUP BY name HAVING
age<‘21’;/>

<CompareOperator>GT</CompareOperator>
<GivenItems>

<Integer>0</Integer>

</ExtraTermIFStatement>

</IFAudienceTargetTrue>
<THENSeekPresentationTarget>

<FirstTerm
STRENGTH=“EXACTLY-DEFINED-BY-TARGET2”

MoneyCostUSD=−5.0E-3”/>

<TemporalControlInformation>

<RecurringDay Day=“WeekDays”/>

<RecurringTime Begin=“18:00:00”
End=“20:00:00”/>
<InsertTimeFromProgramStart
Time=“PT5M30S”/>

</TemporalControlInformation>

</FirstTerm>
<ExtraTerm STRENGTH=“CONTINUE”>

<LogicOperator>AND</LogicOperator>

<ProgramLocation>

...reference to target video program...
</ProgramLocation>

</ExtraTerm>
<ExtraTerm STRENGTH=“EXACTLY-
DEFINED-BY-TARGET2”

MoneyCostUSD=“−1.0E-4”/>
<LogicOperator>ORNOT</LogicOperator>
<TemporalControlInformation>

<RecurringDay Day=“WeekDays”/>

<RecurringTime Begin=“18:00:00”

End=“20:00:00”/>

</TemporalControlInformation>

</ExtraTerm>
<ExtraTerm STRENGTH=“CONTINUE”>

```
<LogicOperator>AND</LogicOperator>
<ProgramLocation>
    <ProgramInformation ProgramId=“CRID”>
          <Genre  type=“main”>Situation
```

comedy</Genre>

</ProgramInformation>

</ProgramLocation>

</ExtraTerm>

</THENSeekPresentationTarget>

<ELSETargetingUnSuccessful
ACTION=“IGNORE-PROGRAM”/>

</TargetingInformation>
Deliver this advertisement to all viewers as specified

Deliver this advertisement to all viewers whose:
Most popular genre of movie is ‘action’
AND

This genre is at least 90% more popular than the next most popular genre of movie

AND

The most popular time for watching action movies is 9:00PM on Friday nights.

<TargetingInformation>
<OperatingPeriod Open=“2000-11-25” Close=“2000-12-25”/>
<ProgramLocation>
...reference to Ad video program...
</ProgramLocation>
<ProductionRights>

<InsertionWithinSelf Right=“Prohibited”/>
<ToBeAnInsert Right=“ Prohibited”/>
<SubstitutionWithinSelf Right=“Prohibited”/>
<ToBeASubstitute Right=“ Prohibited”/>
<OneTimeUse Right=“Unrestricted”/>
<RepeatUse Right=“Unrestricted”/>

</ProductionRights>
<IFAudienceTargetTrue>

<FirstTermIFStatement>
<PreferencesItem SQLQueryPreferences=

“SELECT genre_sub FROM preferences WHERE genre_main = ‘movie’
AND rating = (SELECT MAX(rating) FROM preferences WHERE
genre_main = ‘movie’;) ;”/>

<CompareOperator>EQ</CompareOperator>
<GivenItems>

<String>“action”</String>

</GivenItems>

</FirstTermIFStatement>
<ExtraTermIFStatement>

<LogicOperator>AND</LogicOperator>

<PreferencesExpressionResultItem>

<PreferencesItem1 SQLQueryPreferences=

“SELECT MAX(rating) FROM preferences
WHERE genre_main = ‘movie’
AND genre_sub = ‘action’;”/>

<ExpressionOperator>DIVIDEDBY</ExpressionOperator>

<PreferencesItem2 SQLQueryPreferences=

“SELECT MAX(rating) FROM preferences
WHERE genre_main = ‘movie’
AND genre_sub != ‘action’;”/>

```
  </PreferencesExpressionResultItem>
  <CompareOperator>GE</CompareOperator>
```

<GivenItems>

<Integer>1.9</Integer>
</GivenItems>

</ExtraTermIFStatement>

<ExtraTermIFStatement>

<LogicOperator>AND</LogicOperator>

<PreferencesItem SQLQueryPreferences=

“SELECT view_start_time FROM preferences WHERE genre_main =
‘movie’ AND genre_sub = ‘action’ AND
view_day_of_week = ( SELECT
view_day_of_week FROM preferences WHERE genre_main = ‘movie’
AND genre_sub = ‘action’ GROUP BY view_day_of_week HAVING
MAX(COUNT(view_day_of_week)) ; ) GROUP BY view_start_time
HAVING MAX(COUNT(view_start_time));”/>

<CompareOperator>EQ</CompareOperator>
<GivenItems>
<Integer>1900</Integer>
</GivenItems>

</ExtraTermIFStatement>

</IFAudienceTargetTrue>

<ELSETargetingUnSuccessful ACTION= “IGNORE-PROGRAM”/>

</TargetingInformation>

Targeting with Fuzzy Terms

In the client, or STB, there is a profiling agent that continually builds a database of preferences and behaviors that profile IATV users in the household.

Preferences include affinities for any data field or entries in an electronic programming guide (EPG), examples are titles, genres, channels, and actors. In one instance of the present invention, the agent models patterns of IATV usage behaviors with a behavioral model similar to the clustering engine used at the TV head-end, and extracts key usage information from the behavioral model into a behavioral database. Each entry of the behavioral database has a confidence value generated by a multiplicity of novel techniques presented in detail herein. The database entry confidence registered by the profiling agent reflects an estimate of the structural and sampling quality of the data used to calculate the database entry.

The AD mixer receives AD targeting metadata with restricting query terms to display the associated AD only to selected user's with database entries matching the query constraints. Each AD metadata query term has a minimum confidence threshold term that specifies the lowest confidence level in satisfying the query term, or terms, acceptable to display the targeted AD. For example, an AD targeting constraint such as ‘gender: Male@80% AND age:25-35@50%’ would have the effect of only showing the AD to users the targeting agent has at least 80% confidence in being a male, and at least 50% confidence in being between 25 and 35 years of age. In yet another aspect of confidence level specification, there is an expression level, confidence threshold as follows: ‘(gender: Male AND age:25-35)@80%’. This targeting mode selects for AD display only users that the system has at least 80% confidence in being male and between 25 and 35 years of age. These methods provide flexibility by enabling Ads to specify the most important targeting selection terms, or to specify a range of people that are close enough to the desired targeting profile to show the AD to. The targeting agent only selects profiles from the database whose aggregate per dimension confidence rating satisfies the query limits set by the AD targeting metadata. In yet another aspect of the confidence thresholding system, the query selection filter is stated as a Fuzzy Logic, and not Boolean, expression. The targeting query expression is similar to the probabilistic percentage confidence terms with two notable exceptions: fuzzy membership literals replace the percentage terms, and a fuzzy literal table synchronizes client and server. An exemplar of this query expression mode appears as follows: ‘gender: Male@VERY_SURE AND Age:25-35@FAIRLY_SURE’. This query would select users whom the targeting agent was very sure is a male, and fairly sure lie between 25 and 35 years of age. A fuzzy literal table (FLT) lists the allowable range of fuzzy memberships each AD category may exhibit. An example of a FLT is:

Male: [UNSURE, FAIRLY_SURE,VERY_SURE]

Age: [UNSURE, FAIRLY_SURE,VERY_SURE CERTAIN]

The advantage of this method is that the novice AD agency only specifies the degree of confidence required in intuitive, non-mathematical, terms, and leaves the exact range of confidence percentages up to the targeting agent to decided, and continually optimize. Additionally, the fuzzy method handles the non-deterministic meaning of the percentage confidence terms in the database. The targeting agent learns the percentage confidence rating ranges historically associated with each fuzzy performance level.

Having now described the invention in accordance with the requirements of the patent statutes, those skilled in the art will understand how to make changes and modifications to the disclosed embodiments to meet their specific requirements or conditions. Such changes and modifications may be made without departing from the scope and spirit of the invention, as defined and limited solely by the following claims.

What is claimed is:

1. A method for displaying a TV program to a viewer, comprising:
receiving a plurality of TV programs;
allowing the viewer to select one of the plurality of received TV programs for viewing; and
responding to the viewer selection by:
displaying the viewer selected program; and
displaying additional programs in accordance with previously specified display criteria, the additional programs selected in accordance with the previously determined viewing preferences of the viewer.

2. The method of claim 1, wherein the display criteria include any one or more of display schedule criteria, selected program criteria, and previously determined viewing preferences criteria.

3. The method of claim 1, wherein the additional programs are displayed with the viewer selected program.

4. The method of claim 1, wherein the display criteria are previously specified for each individual additional program.

5. The method of claim 4, further comprising:
receiving a plurality of additional programs;
receiving the display criteria for each additional program together with each respective additional program; and
storing a plurality of additional programs selected in accordance with the previously determined viewing preferences.

6. The method of claim 5, wherein the display criteria include any one or more of display schedule criteria, selected program criteria, and previously determined viewing preferences criteria.

7. The method of claim 2, wherein displaying additional programs comprises:
displaying one or more advertisements.

8. The method of claim 5, wherein controlling the programming displayed to the viewer further comprises:
selecting one or more of the stored additional programs in accordance with the display criteria for display to the viewer.

9. The method of claim 5, wherein receiving the plurality of TV programs and additional programs comprises:
receiving the plurality of programs through one or more broadcast televisions signals, cable television networks, computer networks, or telephone networks.

10. The method of claim 6, wherein receiving the plurality of additional programs comprises:
receiving a plurality of additional programs including targeting parameters related to the previously determined viewing preferences of the viewer, the targeting parameters including one or both of TV viewing preferences and demographic information.

11. A method for displaying a TV program to a viewer, comprising:
transmitting a plurality of TV programs for selection therebetween by the viewer; and
transmitting a plurality of additional programs for selection therebetween in accordance with previously determined viewing preferences of the viewer, the selected additional programs for display to the viewer in accordance with previously specified display criteria.

12. The method of claim 11, wherein the display criteria include any one or more of display schedule criteria, selected program criteria, and previously determined viewing preferences criteria.

13. The method of claim 11, wherein the additional programs are displayed with the viewer selected program.

14. The method of claim 11, wherein the display criteria are previously specified for each individual additional program.

15. The method of claim 14, further comprising:
transmitting a plurality of additional programs; and
transmitting the display criteria for each additional program together with each respective additional program.

16. The method of claim 15, wherein the display criteria include any one or more of display schedule criteria, selected program criteria, and previously determined viewing preferences criteria.

17. The method of claim 12, wherein displaying additional programs comprises:
displaying one or more advertisements.

18. The method of claim 15, wherein transmitting the plurality of TV programs and additional programs comprises:
transmitting the plurality of programs through one or more broadcast televisions signals, cable television networks, computer networks, or telephone networks.

19. The method of claim 16, wherein transmitting the plurality of additional programs comprises:
transmitting a plurality of additional programs including targeting parameters related to the previously determined viewing preferences of the viewer, the targeting parameters including one or both of TV viewing preferences and demographic information.
